(19) United States
(12) Patent Application Publication
(10) Pub. No.: US 2008/0141107 A1
(43) Pub. Date: Jun. 12, 2008

(54) Media rich imaging report generation and presentation

(75) Inventors: Leo R. Catallo, Mercer Island, WA (US); Jonathan P. Hendrich, Seattle, WA (US)

Correspondence Address: FULBRIGHT & JAWORSKI L.L.P, 2200 ROSS AVENUE, SUITE 2800, DALLAS, TX, 75201-2784, US

(73) Assignee: SonoSite, Inc., Bothell, WA (US)

(21) Appl. No.: 11/637,348

(22) Filed: Dec. 12, 2006

(51) Int. Cl. G06F 17/00

(52) U.S. Cl. 715/201; 715/249

(57) ABSTRACT

A system and method that collects and converts raw data and other relevant information related to imaging procedures in order to provide medical personnel, patients, and other authorized parties with a comprehensive media rich report that can be accessed using a platform-independent interface. The invention facilitates the collection and conversion of audio, video, image, and textual data from various sources in order to produce a single comprehensive report that provides the user with maximum utility in evaluating the information derived from one or more the imaging procedures.

### CROSS-REFERENCE TO RELATED APPLICATIONS

This application is related to concurrently filed, co-pending, and commonly assigned U.S. patent application Ser. No. 065744-P032US-10610770 entitled “ORGANIZATION OF DISSIMILAR DATA FOR PLATFORM-INDEPENDENT DIAGNOSTIC IMAGING PRESENTATION,” the disclosure of which application is hereby incorporated herein by reference.

### TECHNICAL FIELD

The present invention relates generally to the processing of imaging device data and more particularly to the processing of imaging device data to generate a media rich report.

### BACKGROUND OF THE INVENTION

An imaging device is any device that acquires information and transforms the information into a form suitable for visual perception and/or electronic use, such as an imaging modality unit that may include related peripheral equipment. An imaging modality unit is a medical system that is used to display an image that accurately represents anatomy. Prevalent imaging modalities used today include ultrasound, X-ray, computer tomography (CT), magnetic resonance imaging (MRI), endoscopic ultrasonography, nuclear medicine imaging, and video endoscopy. Imaging modality units, which may include related peripheral equipment, generally capture or otherwise contain images and patient information that corresponds to a procedure performed for diagnostic purposes. That information is maintained at least temporarily in the imaging device. The information is temporary in the sense that the limited memory component of many imaging devices requires that the information be erased or downloaded prior to the performance of new procedures by the imaging device operator. Otherwise, the information captured by the imaging device may be overwritten as a new procedure is performed. Often the medical practitioner saves the information to a long-term repository or archival storage, which may be a hospital network and its database servers. In the case of a small medical practice, a personal computer or a network of personal computers may be used.

Standards relating to the formatting of imaging modality data and its subsequent storage are limited. The Digital Imaging and Communications in Medicine (DICOM®) standard was created by the National Electrical Manufacturers Association to aid the distribution and viewing of medical images, such as CT scans, MRIs, and ultrasound. DICOM is used as a protocol to converse with various imaging devices, archival systems, and reporting systems. Because DICOM is generally implemented in complex diagnostic environments, such as large hospitals, the systems that utilize this standard tend to be very expensive. As a result, individual modality vendors will often provide an off-platform solution in order to assist individual medical practitioners, medical groups, or small hospitals in the storage and retrieval of information.

Because DICOM is merely a standard, it is incumbent on individual device manufacturers to ensure that their products are fully DICOM-compliant and are capable of communicating with other supposedly DICOM-compliant devices. Device manufacturers that use the DICOM standard are obligated to publish a conforming statement of all the DICOM-compliant components within a particular device.

Even where the DICOM standard is implemented, images that are not DICOM-compliant may be embedded within a DICOM-compliant file, which may prevent the user from viewing the non-DICOM-compliant image within the DICOM platform. Applications that enable viewing of non-DICOM-compliant image formats are limited in that the image format is unavailable for viewing simultaneously with the DICOM-compliant images.

With respect to ultrasound technology, DICOM addresses the extraction of information from the ultrasound machine and its storage onto an archival server. Unfortunately, the implementation of the DICOM ultrasound application can be cost prohibitive for small medical practices due to the significant costs associated with acquiring, implementing, administering, and maintaining the DICOM computing environment. Because the DICOM standard is limited to facilitating communication between imaging devices and archival devices, the DICOM standard does not provide a user with the ability to easily retrieve the archived information or subsequently utilize that information in any meaningful way. And although the DICOM standard is a fixture in large hospital enterprises, its use in small medical practices is practically nonexistent.

Data that is captured by an imaging modality can be stored in the memory of the imaging modality unit, stored/saved on a personal computer or server, or stored/saved onto portable media. Data derived from an imaging modality that is not stored using a DICOM-compliant format is typically stored using a proprietary format. Therefore, in order for the information to be subsequently utilized in a meaningful way, the development, deployment, and use of custom software applications is usually required. It is generally the medical practitioner's responsibility to maintain and manage the information even if a proprietary format is used.

Once raw data is acquired by the imaging modality and exported to an archive or portable media, the organization of that data becomes problematic. Generally, medical practices will not only save the imaging modality data in a proprietary format, but will do so using a haphazard approach to the organization of this data within the archival system. The organization of the files will often be chronological and no effort is made to facilitate subsequent location and extraction of the files from the archival system.

Because custom applications are normally required to efficiently retrieve and utilize the imaging modality data, the costs associated with software development, deployment, and maintenance of these systems can be substantial. Complications further arise when software operates on the imaging modality unit or a personal computer, but not on both. Proprietary applications are needed whenever the data sought to be retrieved uses a proprietary format or is inadequately organized for subsequent retrieval. This is especially true when the data at issue is contained in a variety of forms (e.g., image, video, text) and often multiple proprietary software applications are needed to access, view, and/or print all of the relevant data. For example, one application may be used to display and print an ultrasound image while a separate application may be needed to review a text-based ultrasound report.

Presently, most of the data relating to imaging procedures is managed, stored, and accessed separately. Users are required to access different areas of the computer system in order to play audio files, recall an image or video, review patient demographics, or review a procedure report. For example, a physician that wants to review a video clip from an ultrasound procedure on his personal computer will generally have to pull up the video using a proprietary software program developed by the ultrasound device manufacturer. The physician may have purchased or been provided with the software by the manufacturer, or the physician may not have access to that application at all, which would prevent any subsequent review of the video. Even if the physician has access to the proprietary program that will allow him to view the video of the ultrasound, the video alone may not be as diagnostically useful as a comprehensive presentation of audio data, video data, image data, patient data, and/or report data. In order for the physician to access such a diverse range of data, multiple software applications may be necessary and the simultaneous display of such data may not be possible.

The lack of a standard platform for reviewing this information may prevent other interested parties from reviewing information relating to one or more imaging procedures. Such parties might include the patients, consulting physicians, medical peer review groups, or medical insurance representatives. This lack of information flow may have detrimental consequences to the medical decision-making process by preventing the medical knowledge base from expanding and potentially preventing the patient from making an informed decision regarding his/her healthcare.

### BRIEF SUMMARY OF THE INVENTION

The present invention is directed to systems and methods for generating a media rich report that relates to one or more imaging procedures. Embodiments of the invention convert raw data derived from one or more ultrasound procedures and other sources into formatted data that can be accessed using a platform-independent interface. Textual data may also be translated into the preferred language of the intended user. Once all of the raw data has been properly formatted, the invention generates a dynamic multimedia report that allows for the simultaneous viewing of images, video, audio, and/or textual information related to the imaging procedure(s).

Embodiments of the invention use web technology in order to bring all of the information into the media rich report, which effectively mimics the display of a web page. The media rich report may identify the patient, date, time, nature of the procedure, physician observations, diagnostic findings, and the medical conclusion. The media rich report may also include images, video, audio, and textual information relating to particular measurements, calculations, annotations, and findings derived from one or more imaging procedures. The images, video, audio, and text can be embedded into the comprehensive media rich report, which can be formatted to allow for the simultaneous viewing of some or all of this information via a platform-independent interface. Once the media rich report has been generated, the report can be distributed and redistributed without the need for individual rendering of the data that comprise the report. In a preferred embodiment of the invention, the media rich report can be distributed to users via e-mail and various encryption techniques can be employed to prevent any unauthorized access of confidential medical information.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a functional block diagram of an embodiment of the invention;

FIG. 2 is a flow chart demonstrating an embodiment of the process for processing data and generating a media rich report in accordance with the present invention; and

FIG. 3 illustratively represents an imaging system adapted according to embodiments of the present invention.

### DETAILED DESCRIPTION OF THE INVENTION

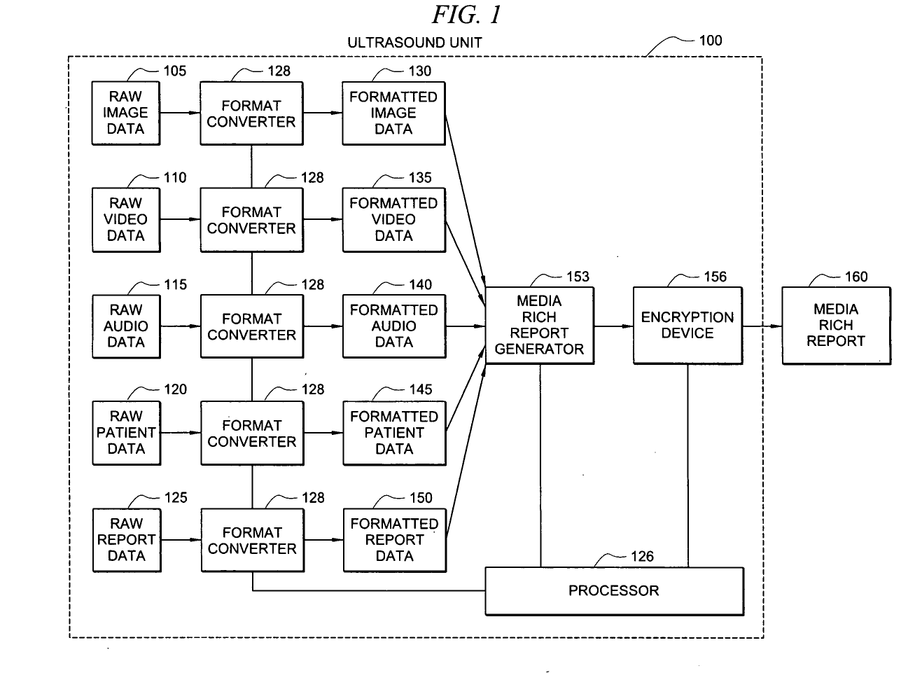

FIG. 1 is a functional block diagram of an embodiment of the invention showing a system for processing the raw data by ultrasound unit 100, converting the raw data into one or more standard formats, and generating a media rich report 160. The specification will generally use ultrasound as an example of an imaging device that can generate a wide variety of relevant data types (e.g., audio, video, text) to aid in understanding the concepts of the present invention. For example, with respect to an ultrasound procedure performed to monitor a developing fetus, the movement of the fetus (video) and its heartbeat (audio) may be of interest to both the patient and the treating physician. However, it should be appreciated that embodiments of the invention may be utilized with respect to various imaging devices, such as X-ray machines, computer tomography (CT) machines, magnetic resonance imaging (MRI) machines, endoscopic ultrasonography units, nuclear medicine imaging machines, and video endoscopy systems.

Once all of the relevant data has been collected and sufficiently formatted (if appropriate), the media rich report generator 153 assembles the report, which utilizes some or all of the formatted data that can be related to one or more patients and/or one or more imaging procedures. In this embodiment, encryption device 156 encrypts media rich report 160 for secure transmission once it leaves ultrasound unit 100. Media rich report 160 of the preferred embodiment can be accessed using a platform-independent interface, which means that no proprietary software or particular computing environment is needed to view media rich report 160. Processor 126 performs many of the functions of the invention as determined by the code that defines the processor's functions within the system, including functions of format converters 128, media rich report generator 153, and encryption device 156. Users of media rich report 160 may include patients, treating physicians, consulting physicians, patient family members, or any other individual or entity authorized to view the medical information contained in media rich report 160.

An ultrasound exam may produce, for example, five general categories of raw data that are processed by the present invention: raw image data, raw patient data, raw report data, raw video data, and raw audio data. Each of these types of data may be dissimilar because the nature of the data may be such that these types of data are stored in different formats (e.g., an image may be embodied in a JPEG file while an audio clip may be embodied in a WAV file). Even raw patient data and raw report data, both of which are primarily textual in nature, may be recorded in dissimilar formats. Any imaging modality used for diagnostic purposes may capture at least some data associated with these general categories.

Raw data is information that is input into the imaging device, received by the imaging device, or recorded by the imaging device using a proprietary or non-standard format. Standard formats include any open source formats or widely supported formats such as JPEG, MPEG, WAV, XML, HTML, and XHTML. For example, an ultrasound device may record video of the ultrasound procedure in a format that is proprietary to the ultrasound device manufacturer. Because this video data is recorded by the imaging device in a proprietary format, which remains unprocessed according to the present invention, it is referred to herein as raw video data. Once the raw data has been formatted according to the present invention so that it no longer uses a proprietary or non-standard format, the raw data becomes formatted data. Similarly, if information is input into the imaging device, received by the imaging device, or recorded by the imaging device in a non-proprietary or standard format in accordance with the present invention, the data is considered formatted data and not raw data. Because data derived from imaging devices has historically been stored in the imaging devices using proprietary formats developed by independent device manufacturers, custom software has generally been needed to view even a single category of raw data derived from one or more imaging procedures.

Raw data can include a variety of information germane to the diagnostic imaging procedure being performed. Raw image data 105 will usually be comprised of one or more images at distinct points in time. For example, a magnetic resonance image (MRI) of a patient's brain may be a single image of the patient's brain at a given point in time. Depending on the proprietary or non-standard format used, raw image data 105 will usually include descriptions of the pixels (e.g., the layout of the pixels, the number of pixels in the image, the number of bits per pixel) and measurements of the pixels (e.g., the number of pixels equated to a centimeter). A single frame of raw image data 105 in a proprietary format might be converted into formatted image data 130 by format converter 128 using code that converts the proprietary format into files such as Joint Photograph Experts Group (JPEG) files, Graphics Interchange Format (GIF) files, and/or Portable Network Graphics (PNG) files, for example, all of which are widely used image formats.

Raw video data 110 may comprise an extension of raw image data 105 by providing a series of images so that the discrete images appear to be moving video. Depending on the proprietary or non-standard format used, raw video data 110 will usually include descriptions of the pixels (e.g., the layout of the pixels, the number of pixels in the image, the number of bits per pixel), measurements of the pixels (e.g., the number of pixels equated to a centimeter), as well information relating to the ordering and the number of individual frames to be transmitted per second. Raw video data 110 can be converted into formatted video data 135 by format converter 128 using code that converts a proprietary or non-standard video format into standard formats such as Motion JPEG (M-JPEG), Windows Media Video version 9 (WMV), and/or Moving Picture Experts Group (e.g., MPEG, MPEG-2, MPEG-4) files, for example, all of which are widely supported and non-proprietary.

Raw audio data 115 can be processed by itself or can be a part of raw video data 110 that may also include sound depending on the format configuration. Raw audio data 115 may include audio files that embody audio data derived from ultrasound unit 100 during an imaging procedure. Raw audio data 115 can be converted into formatted audio data 140 by format converter 128 using code that converts a proprietary or non-standard audio format into a standard format such as Waveform Audio (WAV) format, which is a Microsoft® and IBM® audio file format, MPEG-1 Layer III (MP3), and/or Windows Media Audio (WMA), for example, all of which widely supported audio file formats.

Raw patient data 120 and raw report data 125 are generally comprised of textual and/or numeric data. Raw patient data 120 usually relates to a patient that undergoes one or more imaging procedures and can include such information as patient name, birthday, allergies, and various identification numbers associated with the patient or the imaging procedure. Raw report data 125 usually relates to one or more imaging procedures and can include various diagnostic measurements and results as well as the time, date, and duration of an imaging procedure. Text representing raw patient data 120 or raw report data 125 in a proprietary format might be converted into formatted patient data 145 or formatted report data 150 by format converters 128 using code that converts the proprietary textual format(s) of these raw data categories into a standard text-based format such as Extensible Markup Language (XML). In addition to textual formatting, an extensible language such as XML can be used to define data structures and provide for the efficient navigation of data.

After acquiring the raw data from sources internal and/or external to the imaging device, the present invention converts the raw data into formatted data, if appropriate. Because the source of the raw data-processed by ultrasound unit 100 is likely to be maintained in a manufacturer-specific format and/or environment, such raw data should be converted into formatted data for further processing by the invention. However, if data is input into the imaging device, received by the imaging device, or recorded by the imaging device in a non-proprietary or standard format, the data is considered formatted data (not raw data). As shown in FIG. 1, once the data has been appropriately formatted, media rich report generator 153 can generate the platform-independent structure for the report, embed the dissimilar formatted data within the report, and even translate the textual data into the language of the intended user of the report. Encryption device 156 may be used to encrypt the final media rich report 160 so that it may be exported from the system in a secure format.

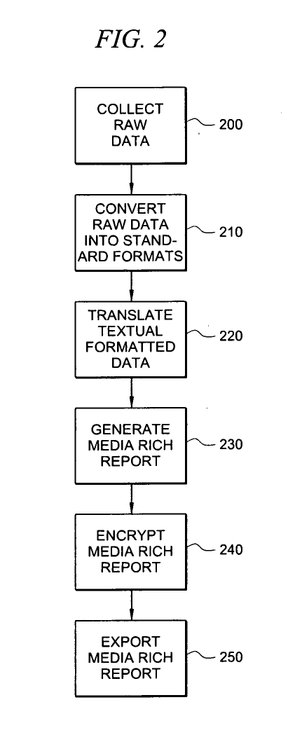

FIG. 2 is a flow chart demonstrating an embodiment of a process for processing data and generating a media rich report, but none of the individual processes described in FIG. 2 is essential to the present invention. Process 200 collects the raw data in its various forms from sources that are either internal or external to the imaging device. Process 210 then converts this raw data into formatted data that utilizes standard formats.

Process 220 translates formatted textual data into the preferred language of the intended user of the media rich report. In one embodiment of the invention, raw data input into the system may be derived from voice recognition software and translated, directly or indirectly, into the preferred language of the user of the media rich report. At this stage, the textual data (e.g., formatted report data, formatted patient data) will be formatted and be embodied in a standard text-based format such as XML. Many of the functions used to produce the media rich report can be performed using a standard technology called Extensible Stylesheet Language Transformations (XSLT). For example, XSLT can be used in process 220 to translate the formatted textual data into another language if an alternative language is preferred. The translated textual data may temporarily remain in XML form or may be converted directly into Hypertext Markup Language (HTML) in accordance with subsequent processes of the invention.

Process 230 generates the media rich report by incorporating formatted data into a comprehensive multimedia presentation. HTML is a text file with tags that specify how content is to be formatted and displayed in the media rich report. Therefore, HTML can be used to create the layout that defines the media rich report and the image data, video data, and audio data from the ultrasound procedures can be embedded within the HTML report in a manner that mimics the display of a typical web page containing text, graphics, video, images, and/or audio. Once the HTML report structure has been generated, XSLT can be used to selectively extract data and other textual information from formatted data files for inclusion in the media rich report. The XSLT extraction and incorporation of textual data may also include converting the formatted textual data (e.g., XML format) into HTML format that may be used for the report structure. Although the foregoing uses HTML as an example of the markup language that can be used to format the textual data or to specify how content is to be formatted and displayed, it is to be expressly understood that XHTML can be used for these purposes as well. Other standard programming languages, such as C++, may also be needed to facilitate the inclusion of formatted audio data (e.g., WAV files), formatted video data (e.g., MPEG files), and formatted image data (e.g., JPEG files) into the media rich report by embedding the files within the media rich report.

Process 240 encrypts the media rich report so that only authorized users can access the medical information that may be contained in the report. The information contained in the media rich report may contain patient demographics and results from medical imaging procedures, which implicate the Health Information Portability Accountability Act (HIPAA). Under HIPAA, the practitioner is responsible for maintaining the security of the patient information, and once the media rich report is generated, encryption of the information may be desirable in order to ensure the confidentiality of patient information. Therefore, one embodiment of the invention includes an encryption function that scrambles/encrypts the confidential information. In this embodiment, a user must be a designated recipient of the media rich report in order to decrypt the information and view the report.

The encryption can be performed using any number of standard technologies that support public and private encryption keys. For example, prior to a patient reviewing the report, the physician may assign the patient an authentication code that will enable the patient to decrypt the media rich report. This is generally accomplished by issuing the patient a public or private encryption key, which is used to decrypt the media rich report. The platform-independent interface used to view the media rich report, such as a standard web browser, should support whatever encryption form is being used (e.g., 128-bit encryption).

In a preferred embodiment, XSLT is used to perform the encryption function in such a way that various fields of the report are encrypted while the basic structure of the report is visible over the platform-independent interface display. For example, an unauthorized individual attempting to access the report might be able to view the report outline, but the fields of the report that contain confidential information would remain encrypted. A user can only view the content of the report with the correct encryption key in this embodiment of the invention.

Process 250 exports the media rich report from the system so that authorized users may view the report. Process 250 can be achieved in a number of ways and the party in charge of generating and distributing the report may utilize one or more available distribution options. In one embodiment, the media rich report is sent via e-mail to the intended user(s) of the report. In another embodiment, the media rich report is stored on a web server so that authorized users can log onto a web site and view the report using a platform-independent interface, such as standard web browser, from a remote location. Yet another embodiment of the invention facilitates the storage of the media rich report onto portable media, as is more completely disclosed in relation to diagnostic imaging presentations in concurrently filed, co-pending, and commonly assigned U.S. patent application Ser. No. 065744-P032US-10610770 entitled “ORGANIZATION OF DISSIMILAR DATA FOR PLATFORM-INDEPENDENT DIAGNOSTIC IMAGING PRESENTATION.”

In one embodiment of the invention, the imaging device generates all of the report components in standard formats. In another embodiment, the imaging device communicates data from the imaging device to a personal computer (PC) or computer network. This data can be either raw data components that can be transformed into standard formats or data that originates in standard formats. In either instance, the data format conversion and/or the generation of the media rich report can be accomplished, in whole or in part, by the imaging device or by a PC or computer network after receiving the appropriate data. The imaging device would transfer the data to the PC or network either as raw data or as formatted data (e.g., XML, JPEG, WAV). In an alternative embodiment of the invention, the entire process is performed internal to the imaging device, which produces completely formatted media rich reports. Regardless of which embodiment is implemented, software that performs the method and implements the system according to the present invention may be created using a variety of commercially available developmental tools, such as C++ or Java. These embodiments of the present invention improve on the prior art even when the functions are performed by a personal computer or computer network because of the comprehensive, intuitively-formatted solution that is provided to the user via the conversion of raw data and the generation of the comprehensive media rich imaging report, which can be distributed to authorized individuals who can access the platform-independent report without the need for proprietary software.

The media rich report can be accessed using a platform-independent interface because the report and all of the data can be formatted so that no proprietary or non-standard software is needed. One embodiment of a platform-independent interface that natively supports a variety of standard formats is a standard web browser and any plug-ins that allow the user to view computer files that are written in non-proprietary or open source formats. This embodiment of the invention can be used in any sort of computing environment equipped with a standard web browser and standard plug-ins, regardless of the computing platform (e.g., personal computer, Macintosh®, Unix®). In this way, the distribution and redistribution of custom software is avoided by leveraging widely available web technology to allow for the rendering of diagnostic information on a variety of different platforms. Whether the user accesses the media rich report by visiting a web site via the Internet, receives the report via e-mail, or accesses the report using portable media, the report is viewed using a platform-independent interface so that no proprietary or non-standard software programs are needed.

The media rich report is graphically tailored so that the user has a meaningful viewing experience resulting from the inherently intuitive display that mimics a web page and the multiple media formats that can be incorporated into the report. For example, the media rich report can allow the user to simultaneously play a video clip of a Doppler trace from a cardiac study while listening to the accompanying audio and/or the physician's narration of the procedure. The report is interactive in that it allows the user to control the playback of any of the dynamic portions of the report, which may include multiple audio and/or video portions of this multimedia presentation.

One embodiment of the invention allows for the comparison of imaging procedures and data to promote informed medical diagnoses. For example, the media rich report could focus on multiple images related to a single imaging procedure or a progression of imaging procedures taken for purposes of comparison. A progression of imaging procedures might occur when a patient has an annual gynecological exam and her physician discovers evidence of an ectopic pregnancy by performing an ultrasound procedure. Still unable to reach a definitive medical conclusion from the results of the initial ultrasound procedure, the physician instructs the patient to return later in the day after having consumed large quantities of water in hopes that the increased hydration will produce more definitive results from a second ultrasound procedure. This embodiment of the invention would allow a user to dynamically compare the results from the two ultrasound procedures in order to obtain a more comprehensive picture of the anatomical condition of the patient, which would allow the medical practitioner to make a more informed diagnosis. Such comparisons can be presented in a myriad of ways, such as incorporating all of the relevant information onto a single media rich report or by simultaneously viewing two separate media rich reports in separate windows of a personal computing environment.

Another embodiment of the invention provides for aggregate reporting of imaging procedures. For example, a patient may have an ultrasound cardiac study performed every six months. In between cardiac studies, the patient undergoes a surgical procedure relating to his heart. The comparative analysis that can be performed using the present invention allows the physician to evaluate the patient's condition both before and after the surgical procedure. In other words, this type of reporting structure produces an aggregate media rich report that is created using content derived from prior ultrasound procedures as well as content derived from the most recent ultrasound procedure. The report might also span multiple studies that occur over considerably larger periods of time before treatment and after treatment. By extracting, formatting, and integrating the patient data and data derived from the imaging procedure, which may be either disparate in format or disparate in time, a unified, comprehensive, media rich report can be generated that will allow the physician to accurately assess the results of a single imaging procedure or reveal a more comprehensive picture of treatment over a period of time.

Still another embodiment of the invention allows the practitioner to compare one patient's media rich report with other media rich reports involving the same imaging procedure in order to enable a comparison that increases the chances of rendering an accurate diagnosis and prescribing an effective course of treatment. Databases containing media rich reports can be established to allow for direct comparison of imaging data between media rich presentations performed years and/or continents apart. This embodiment of the invention allows for direct comparison of all or some of the imaging data within the media rich presentation to improve the chances that a correct diagnosis will be made and a successful course of treatment will be prescribed.

When implemented via computer-executable instructions, various elements of embodiments of the present invention are in essence the software code defining the operations of such various elements. The executable instructions or software code may be obtained from a readable medium (e.g., hard drive media, optical media, EPROM, EEPROM, tape media, cartridge media, flash memory, ROM, memory stick) or communicated via a data signal from a communication medium (e.g., the Internet). In fact, readable media can include any medium that can store or transfer information.

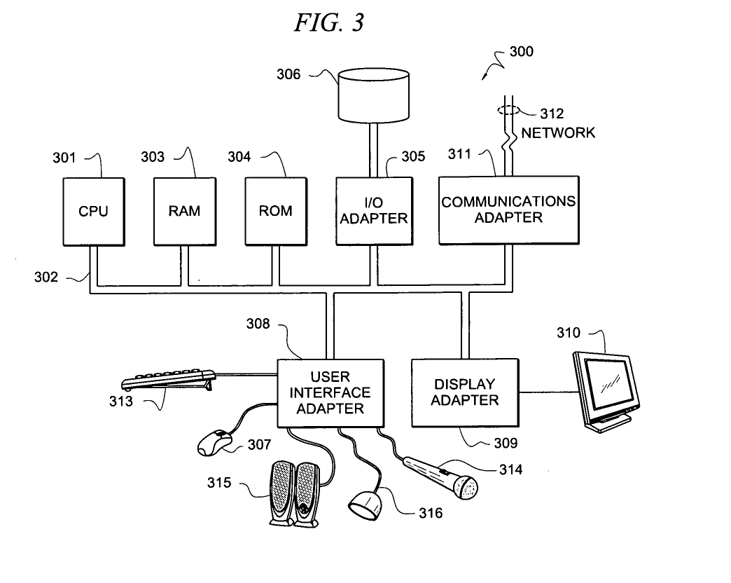

FIG. 3 illustrates processor-based imaging system 300 adapted according to embodiments of the present invention. That is, imaging system 300 comprises an example system on which embodiments of the present invention may be implemented. Central processing unit (CPU) 301 is coupled to system bus 302. CPU 301 may be any general purpose CPU. However, the present invention is not restricted by the architecture of CPU 301 as long as CPU 301 supports the inventive operations as described herein. CPU 301 may execute the various logical instructions according to embodiments of the present invention. For example, CPU 301 may execute machine-level instructions according to the exemplary operational flows described above in conjunction with FIG. 2.

Imaging system 300 preferably includes random access memory (RAM) 303, which may be SRAM, DRAM, SDRAM, or the like. Imaging system 300 preferably also includes read-only memory (ROM) 304 which may be PROM, EPROM, EEPROM, or the like. RAM 303 and ROM 304 hold user and system data and programs, as is well known in the art. Imaging system 300 preferably also includes input/output (I/O) adapter 305, communications adapter 311, user interface adapter 308, and display adapter 309. I/O adapter 305, user interface adapter 308, and/or communications adapter 311 may, in certain embodiments, enable a user to interact with imaging system 300 in order to input information, such as patient or report data.

I/O adapter 305 preferably connects to storage device(s) 306, such as one or more of hard drive, compact disc (CD) drive, floppy disk drive, tape drive, etc. to imaging system 300. The storage devices may be utilized when RAM 303 is insufficient for the memory requirements associated with storing the necessary data. Communications adapter 311 is preferably adapted to couple imaging system 300 to a computer network 312. User interface adapter 308 couples user input devices, such as transducer probe 316, keyboard 313, pointing device 307, and microphone 314 and/or output devices, such as speaker(s) 315 to imaging system 300. Display adapter 309 is driven by CPU 301 to control the display on display device 310 to, for example, display the imaging presentation prior to its being recorded/saved on the portable media.

It shall be appreciated that the present invention is not limited to the architecture of system 300. For example, any suitable processor-based device may be utilized, including, without limitation, imaging devices, imaging modality units, personal computers, laptop computers, handheld computing devices, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention, including structures incorporated into imaging devices or computer systems.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for preparing a media rich report based upon information derived from one or more imaging devices comprising:
collecting dissimilar raw data from one or more imaging devices;
converting said raw data into formatted data;
generating structure for platform-independent report that is accessible using a platform-independent interface; and
embedding dissimilar formatted data into said structure for multimedia presentation.

2. The method of claim 1 wherein said imaging devices are ultrasound units.

3. The method of claim 1 wherein said raw data is data embodied in a proprietary or non-standard format.

4. The method of claim 1 wherein said formatted data is data embodied in a non-proprietary, standard, or open source format.

5. The method of claim 1 wherein said dissimilar data is data embodied in different formats due to the nature of the data (i.e., text, audio, image, video).

6. The method of claim 1 wherein said platform-independent report is a multimedia presentation formatted so that no proprietary or non-standard software is needed to view the presentation.

7. The method of claim 1 wherein said platform-independent report is a multimedia presentation that can be viewed using a standard web browser and any plug-ins that allow the user to view computer files that are embodied in a non-proprietary, standard, or open source format.

8. The method of claim 1 further comprising translating textual data into the preferred language of the user of the media rich report.

9. The method of claim 1 further comprising encrypting said media rich report.

10. The method of claim 1 further comprising transmitting said media rich report to the user via e-mail.

11. The method of claim 9 further comprising decrypting said media rich report.

12. The method of claim 1 further comprising storing said media rich report on a web server.

13. The method of claim 1 further comprising storing said media rich report onto portable media.

14. A system for preparing a media rich report based upon information derived from one or more imaging devices, the system comprising:
one or more imaging devices for collecting raw data;
one or more format converters that convert said raw data into standard formats; and
a media rich report generator that generates a platform-independent imaging presentation.

15. The system of claim 14 wherein said imaging devices are ultrasound units.

16. The system of claim 14 wherein said media rich report generator also translates textual data into the preferred language of the user of said media rich report.

17. The system of claim 14 further comprising an encryption device that encrypts the content of said media rich report.

18. The system of claim 17 further comprising a decryption device that decrypts the content of said media rich report.

19. The system of claim 14 further comprising a web server on which to store said media rich report.

20. The system of claim 14 further comprising portable media on which to store said media rich report.

21. A system for preparing a media rich report based upon information derived from one or more imaging devices, the system comprising:
means for collecting dissimilar raw data from one or more imaging devices;
means for converting said raw data into formatted data;
means for generating structure for platform-independent report that is accessible using a platform-independent interface; and
means for embedding dissimilar formatted data into said structure for multimedia presentation.

22. The system of claim 21 wherein said imaging devices are ultrasound units.

23. The system of claim 21 further comprising the means for translating textual data into the preferred language of the user of said media rich report.

24. The system of claim 21 further comprising means for encrypting the content of said media rich report.

25. The system of claim 24 further comprising means for decrypting the content of said media rich report.

26. The system of claim 21 further comprising means for distributing said media rich report over the Internet.

27. The system of claim 21 further comprising means for posting said media rich report on one or more Internet web sites.

28. The system of claim 21 further comprising means for storing said media rich report onto portable media.

29. An article of manufacture comprising:
a computer usable medium having computer readable program code means embodied therein for organizing dissimilar data derived from one or more imaging devices to create a platform-independent media rich report, the computer readable program means in said article of manufacture comprising:
computer readable program code means for causing a processor to collect dissimilar raw data from one or more imaging devices;
computer readable program code means for causing a processor to convert said raw data into formatted data;
computer readable program code means for causing a processor to generate structure for platform-independent report that is accessible using a platform-independent interface; and
computer readable program code means for causing a processor to embed dissimilar formatted data into said structure for platform-independent report.

30. The article of manufacture of claim 29 wherein said imaging devices are ultrasound units.

31. The article of manufacture of claim 29 further comprising computer readable program code means for causing a processor to translate textual data into the preferred language of the user of said media rich report.

32. The article of manufacture of claim 29 further comprising computer readable program code means for causing a processor to encrypt said media rich report.

33. The article of manufacture of claim 32 further comprising computer readable program code means for causing a processor to decrypt said media rich report.

34. The article of manufacture of claim 29 further comprising computer readable program code means for causing a processor to export said media rich report to the user of said media rich report via e-mail.

35. The article of manufacture of claim 29 further comprising computer readable program code means for causing a processor to store said media rich report on a web server.

36. The article of manufacture of claim 29 further comprising computer readable program code means for causing a processor to store said media rich report onto portable media.
